(19) United States
(12) Patent Application Publication
(10) Pub. No.: US 2013/0229273 A1
(43) Pub. Date: Sep. 5, 2013

(54) TACTILE INPUT DEVICE, MICROPROCESSOR SYSTEM AND METHOD FOR CONTROLLING A TACTILE INPUT DEVICE

(71) Applicants: Marcos Nodar Cortizo, Colomiers (FR); Auger Florent, Toulouse (FR); Patrice Bertrand, Tournefeuille (FR)

(72) Inventors: Marcos Nodar Cortizo, Colomiers (FR); Auger Florent, Toulouse (FR); Patrice Bertrand, Tournefeuille (FR)

(73) Assignee: FREESCALE SEMICONDUCTOR, INC., Austin, TX (US)

(21) Appl. No.: 13/881,157

(22) PCT Filed: Nov. 25, 2010
(86) PCT No.: PCT/IB2010/003422

§ 371 Date: Apr. 24, 2013

(51) Int. Cl. G08B 6/00

(52) U.S. Cl. CPC G08B 6/00
USPC 340/407.2

(57) ABSTRACT

The present invention pertains to a tactile input device comprising a control device, a proximity sensor unit arranged to provide a proximity detection signal to the control device, a tactile acoustic wave sensor unit operable in a low power mode and a high power mode according to a mode control signal from the control device, wherein the control device is arranged to control the power mode of the tactile acoustic wave sensor unit by providing a mode control signal based on the proximity detection signal received from the proximity sensor unit. The present invention also pertains to a microprocessor system comprising such a tactile input device and a corresponding method for controlling a tactile input device.

### FIELD OF THE INVENTION

The present invention pertains to a tactile input device, a microprocessor system and a method for controlling a tactile input device.

### BACKGROUND OF THE INVENTION

In modern communication and computer systems, tactile input devices like tactile pads or tactilescreens are increasingly. In addition to capacitive and resistive tactile sensors, acoustic wave sensors are utilized for sensing and receiving tactile input from a user. Acoustic wave sensors receive waves caused by a tactile onto an area and translate the received information about the waves into information regarding the location of the tactile and/or a movement performed while in contact with the region.

### SUMMARY OF THE INVENTION

The present invention provides a tactile input device, a microprocessor system and a method for controlling a tactile input device as described in the accompanying claims.

Specific embodiments of the invention are set forth in the dependent claims. These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 schematically shows an example of a tactile input device.

FIG. 2 schematically shows an example of a tactile acoustic wave sensor unit.

FIG. 3 schematically shows an additional example of a tactile input device.

FIG. 4 schematically shows a method for controlling a tactile input device.

### DETAILED DESCRIPTION OF THE PREFERRED EMBODIMENTS

Because the illustrated embodiments of the present invention may for the most part, be implemented using electronic components, software and circuits known to those skilled in the art, details will not be explained in any greater extent than that considered necessary for the understanding and appreciation of the underlying concepts of the present invention and in order not to obfuscate or distract from the teachings of the present invention.

In the context of this description, a tactile acoustic wave sensor unit may refer to an arrangement of one or more sensors arranged to detect and/or sense acoustic waves caused by a tactile or a movement and associated logic circuits. A tactile detection area may be an area in which a tactile is being detected by the tactile acoustic wave sensor unit. The tactile detection area may essentially be a two-dimensional area.

The tactile acoustic wave sensor unit may be arranged to detect tactile contact of an object contacting the tactile detection area and/or movement of an object contacting the tactile detection area. The one or more sensors of the tactile acoustic wave sensor unit may be piezoelectric sensors. It may be envisioned to arrange the one or more sensors of the tactile acoustic wave sensor unit such that they surround the tactile detection area. The tactile acoustic wave sensor unit may be operable in at least two power modes, a high power mode and a low power mode. It may be considered that the tactile acoustic wave sensor unit draws a lower amount of power in low power mode than in high power mode. The tactile acoustic wave sensor unit may be operable in more than two power modes. The tactile acoustic wave sensor unit may comprise logic, in particular logic circuits, for detection of a tactile and/or movement. In the high power mode, the tactile acoustic wave sensor unit may be operated in a detection mode to detect a tactile and/or movement on the tactile detection area. Detecting a tactile may comprise sensing a tactile and/or movement in the tactile detection area, providing sensing data and/or acquiring and/or validating sensing data and/or localising a tactile and/or movement in the tactile detection area.

A proximity detection region may be a spatial region extending in three dimensions. The proximity detection region may extend above and/or around the tactile detection area. The proximity detection region may include or border to the tactile detection area. A proximity sensor unit may be any kind of sensor unit capable of detecting an object in a proximity detection region or movement of an object into the proximity detection region without requiring a contact or tactile of an object to a solid detection element. A proximity sensor unit may comprise one or more capacitance sensors. A capacitance sensor may be configured to be sensitive enough to detect an object, a movement of an object in the proximity detection region and/or movement of such an object into the proximity detection region. It may be considered that a proximity sensor unit requires less energy over a given time period than a tactile acoustic wave sensor unit in a high power mode in the same time period.

The object to be detected may be a finger, a hand, a tactile pen or any other object. The object to be detected may be the same for both the proximity detection sensor unit and the tactile acoustic wave sensor unit.

A tactile may be considered to be caused by an object contacting the tactile detection area. A movement of an object contacting the tactile detection area may be considered to be a tactile or tactile event to be detected by the tactile acoustic wave sensor unit.

An acoustic wave sensor may be considered to be arranged to sense the surface waves or acoustic waves caused on a tactile detection area by a tactile and/or movement under contact with the tactile detection area.

Such acoustic waves or surface waves may appear in a close temporal correlation with a contact with the tactile detection area being established by an object. After contact has been established, even if a tactile is being held, the level of measureable surface wave activity strongly declines over time. It may be considered that a tactile acoustic wave sensor unit has only a limited timeframe in which it can pick up or sense a tactile input to the tactile detection area by an object or a user, even if the tactile input is held or maintained for longer than the this timeframe. This is in contrast to resistive or capacitive sensors, which may be able to detect or sense a tactile input during the whole of the contact time.

On the other hand, a tactile acoustic wave sensor unit does not require special layers to be added to the tactile detection area to be able to pick up or sense a tactile input. Acoustic waves caused by a tactile or tactile input may be picked up on the edges of the tactile detection area, without the need of providing elements of the tactile acoustic wave sensor unit in or above/below the tactile detection area. This permits utilizing more of the space of the tactile detection area for other purposes. The tactile detection area may be increased in comparison to other detection technologies. For example in the case of a display, the space may be used for providing components for displaying image or graphical information.

Also, the overall image quality and in particular the legibility of text on a display may be improved, as additional layers of detection component tend to obscure an image.

Thus, the use of acoustic wave sensor technology allows construction of thinner and better tactilescreens with higher image quality. Due to the small timeframe available for sensing or detecting a tactile input, the tactile acoustic wave sensor unit may be run in a detection mode for a considerable amount of time, in which it may be operated to be able to sense a tactile input and to process corresponding signals to be able to detect a location of the tactile input. This may be required as the occurrence of a tactile event is not predictable and may happen at any time. The detection mode may be considered to be a high-power mode. This may cause an unwanted drain of power, limiting the duty time in particular of mobile devices. To avoid an unwanted power drain, it may be envisioned to operate at least certain components of a tactile acoustic wave sensor unit in a low power mode, until a proximity sensor unit provides a proximity detection signal indicating a detection of a nearby object, for example a hand or a finger. Based on the proximity detection signal, the tactile acoustic wave sensor unit and/or its components may be woken up or brought into a high power mode, before a tactile input event occurs. Thus it may only be required to operate the tactile acoustic wave sensor unit in a high power mode when an input is expected, lowering the power requirements of the tactile input device. On the other hand, the use of the proximity sensor unit permits the tactile acoustic wave sensor unit to operate in high power or detection mode when a first tactile event happens so that it may react to the first tactile input.

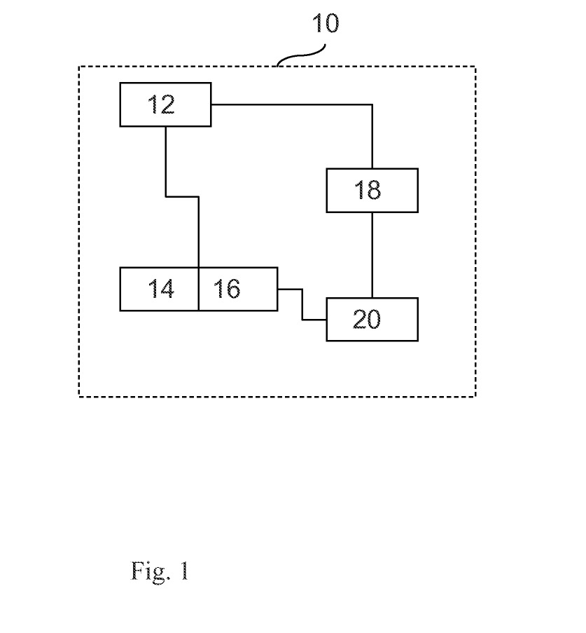

Now referring to FIG. 1, there is schematically shown a tactile input device 10. Tactile input device 10 may comprise a proximity sensor unit 12. Proximity sensor unit 12 may be arranged to detect an object or a movement of an object in a proximity detection region 14. The proximity sensor unit 12 may comprise one or more than one capacitive sensors. The proximity sensor unit 12 may comprise an electrode surrounding or at least partially surrounding a display device. It may be considered that the proximity sensor unit 12 comprises an electrode made of metallic paint and/or conductive paint and/or a wire and/or a metallic band and/or conductive band and/or a metallic layer.

The proximity detection region 14 may be a spatial region. The proximity detection region 14 may extend up to a certain predetermined height above a tactile detection area 16. It may be considered that the proximity detection region 14 surrounds the tactile detection area 16. It is feasible that the proximity detection region 14 is configured such that an object intended to contact a point of the tactile detection area 16 has to pass through the proximity detection region 16. Configuration of the proximity detection region 14, for example defining the height of the proximity detection region 14 over the tactile detection area 16, may be performed dependent on characteristics of components of the proximity sensor unit 12 like e.g. sensors and/or control logic and/or software. The configuration of the proximity detection region 14 may be predetermined by setting parameters and/or characteristics of such components.

The tactile detection area 16 may be any area intended for detection of a tactile input. It may be considered to be a tactile screen or a tactile pad. Tactile detection area 16 may be co-extensive or almost co-extensive with a display area arranged to display graphical information or text information. The display area may be an area of a display of a smartphone, a mobile phone, a personal digital assistant, a computer terminal, a laptop, a webpad, an eBook or any other kind of microprocessor system utilizing a display. The tactile detection area 16 may be considered to be a part of the tactile input device 10.

The proximity sensor unit 12 may be arranged to provide a proximity detection signal. The proximity detection signal may be considered to be indicative of a detection or non-detection of an object or the movement of an object in or into the proximity detection region 14. The proximity sensor unit 12 and a control device 18 may be connected to be able to exchange signals. It may be contemplated that the proximity sensor unit 12 is arranged to provide the proximity detection signal to the control device 18.

The control device 18 may be arranged to receive a proximity detection signal from the proximity sensor unit 12. The control device 18 may be any kind of microprocessor or microcontroller. It may be envisioned that the control device 18 is connected to a tactile acoustic wave sensor unit 20. The control device 18 may be arranged to control a power mode of the tactile acoustic wave sensor unit 20 by providing a mode control signal based on the proximity detection signal received from the proximity sensor unit 12. The mode control signal may be provided to the tactile acoustic wave sensor unit 20 by the control device 18.

The acoustic wave sensor unit 20 may be operable in a low power mode and in a high power mode. The tactile acoustic wave sensor unit 20 may be arranged to detect a tactile input into a predetermined tactile detection area 16. It may be considered that the acoustic wave sensor unit 20 is operated in the low power mode or the high power mode according to the mode control signal from the control device 18. The acoustic wave sensor unit 20 may be arranged to receive the mode control signal from the control device 18. The acoustic wave sensor unit 20 may be arranged to sense and/or detect acoustic waves caused by a tactile, a contact and/or a movement under contact on the tactile detection area 16. It may be considered that the acoustic wave sensor unit 20 is connected to the tactile detection area 16, for example via sensors arranged to sense acoustic waves like piezoelectric sensors. Such sensors may be arranged to surround the tactile detection area 16. It may be envisioned that the tactile acoustic wave sensor unit 20 is arranged to detect a tactile input to a display. A display, a screen or part of a display or a screen may be considered to be a tactile detection area 16. The acoustic wave sensor unit 20 may comprises one or more sensors. The sensors may be configured to sense and/or detect acoustic waves, and in particular may be piezoelectric sensors.

It may be envisioned that the control device 18 is arranged to control the tactile acoustic wave sensor unit 20 to operate in a high power level upon reception of a proximity detection signal indicating the detection of an object or movement in the proximity detection region 14. Based on the corresponding mode control signal, the tactile acoustic wave sensor unit 20 may be switched to the high power mode, which may be a mode in which it is able to detect and localize a tactile input in the tactile detection area 16. Switching to the high power mode may be performed after reception of the proximity detection signal by the control device 18, for example within a predetermined first time after reception. It may be feasible that switching to high power mode is performed within a predetermined second time after reception of the mode control signal by the tactile acoustic wave sensor unit 20. The first and/or second time may be chosen such that the tactile acoustic wave sensor unit 20 is in high power mode or has been woken up before an expected tactile input by the object detected by the proximity sensor unit 12 occurs. It may be considered that the second time is shorter than the first time. The first time or the second time may be several hundreds of milliseconds. It may be feasible that the first time and/or the second time is below 384 ms. Several hundred milliseconds and in particular 384 ms may be considered to be a typical timescale between a proximity detection and a tactile input occurring on the tactile detection area 16. Generally, the proximity signal from the proximity detection system 12 may be required to be generated early enough so that the acoustic wave sensor unit 20 is operational when the tactile on surface 16 effectively occurs. It may be envisioned that the control device 18 controls the tactile acoustic wave sensor unit 20 into the low power mode after a predetermined time after reception of the proximity detection signal, for example in the case a proximity event was generated and detected, but not followed up by a tactile event. The control device 18 may control the tactile acoustic wave sensor unit 20 into the high power mode for a predetermined time after reception of the proximity detection signal. It may be considered that the control device 18 is arranged to control the tactile acoustic wave sensor unit 20 into the low power mode if during a predetermined waiting time no tactile event has been detected by the tactile acoustic wave sensor unit 20 and/or the proximity sensor unit 12 did not provide a proximity detection signal during a predetermined proximity waiting time. Proximity waiting time and waiting time may be equal. It may be considered that the waiting time is longer or shorter than the proximity waiting time. There may be envisioned a microprocessor system comprising a tactile input device as described herein. The microprocessor system may for example be a personal computer, portable computer, laptop, eBook, webpad, smartphone, mobile phone, etc. Generally, the control device 18 may be considered to be a part of the tactile acoustic wave sensor unit 20 and/or the proximity sensor unit 12. The control device 18 may be considered to be separate to the tactile acoustic wave sensor unit 20 and the proximity sensor unit 12. The control device 18 may be a CPU of a microprocessor system. It may be envisioned that control device 18 comprises a plurality of separate electronic control units assigned to different tasks, devices and/or units of the tactile input device or the microprocessor system. This may be the case particularly in the case that the control device is a multiprocessor or multi-core system.

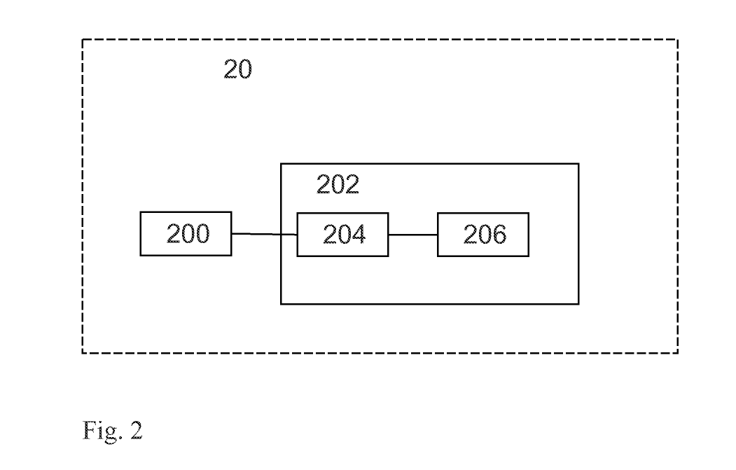

FIG. 2 schematically shows a tactile acoustic wave sensor unit 20, which may be a tactile acoustic wave sensor unit 20 as shown with reference to FIG. 1. The tactile acoustic wave sensor unit 20 may comprise a tactile sensing logic 200. The tactile sensing logic 200 may comprise or be connected to one or more acoustic wave sensors arranged to sense a tactile and/or movement under contact on a tactile detection area, for example piezoelectric sensors. The tactile sensing logic 200 may comprise logic circuitry and/or software arranged to detect random impacts on the tactile detection area 16. The logic circuitry may comprise for example a threshold detector based on diodes and threshold comparators. It may be contemplated that the tactile sensing logic 200 has low power requirements. The tactile acoustic wave sensor unit 20 may comprise a tactile localization unit 202 connected to the tactile sensing logic 200. The tactile localization unit 202 may comprise an acquisition logic 204. The acquisition logic 204 may be arranged to receive and/or acquire and/or sample signals provided by the tactile sensing logic 200. It may be contemplated that the acquisition logic 204 is arranged to sample an acoustic wave signal generated by a tactile on the tactile detection area 16 and/or provided via the tactile sensing logic 200. The acquisition logic 204 may be configured to characterize the signals provided by the tactile sensing logic 200 and/or to characterize a tactile sensed. It may be arranged to distinguish noise from tactile events. It may be contemplated to configure the acquisition logic 204 such that it samples as much of a signal related to a tactile to be sensed or detected as possible, to be able to provide a reliable distinction between noise and real tactile events.

The acoustic wave sensor unit 20 may comprise a localization logic 206. The localization logic 206 may be seen as part of the tactile localization logic 202. It may be contemplated that the localization logic 206 is implemented at least partly in software, which may be run for example on a microprocessor or microcontroller of a device the tactile input device is a part of. The localization logic 206 may be connected to the acquisition logic 204. It may be arranged to receive data provided by the acquisition logic, e.g. data or samples regarding a detected tactile event. The localization logic 206 may be arranged to post-process data received from the acquisition logic 204, for example to calculate coordinates of a detected tactile event or the direction of movement or the shape of a pattern formed by a tactile input relative to the tactile detection area 16. The post-processed data may be provided by the localization logic 206 to further logic units, devices or software processes connected to it. The localization logic 206 may require a relatively high level of power, as it has to perform complex calculations. It may be considered that the localization logic usually only runs in a high power mode when it actually performs calculation on data provided by the acquisition logic 204. If no such data is present, the localization logic 206 may be operated in a low power mode, for example it may be turned off or switched into a sleep mode. It may be contemplated that the acquisition logic 204 and/or a control device 18 provides a signal based upon which the localization logic 206 is switched into a low power mode or high power mode.

It may be feasible that the component tactile sensing logic 200 and/or tactile localization unit 202 and/or acquisition logic 204 and/or localization logic 206 of the acoustic wave sensor unit 20 is or are connected to a control device 18 (not shown). The control device 18 may be arranged to control the tactile acoustic wave sensor 20 respectively one or more of its components to switch between a high power mode and a low power mode. It may be contemplated that in a low power mode of the tactile acoustic wave sensor unit 20 the tactile localization unit 202 and/or the acquisition logic 204 and/or the localization logic 206 are turned off or switched into a sleep phase, in which they require less power than in their active state. It may be considered that the control device 18 is arranged to provide a mode control signal to the tactile acoustic wave sensor 20 and/or the tactile sensing logic 200 and/or the tactile localization unit 202 and/or the acquisition logic 204 and/or the localization logic 206. The mode control signal may be indicative of which power mode the respective unit or logic addressed by the signal is to be operated in. It may be feasible that the tactile sensing logic 200 and/or the tactile localization unit 202 and/or the acquisition logic 204 and/or the localization logic 206 and/or the tactile acoustic wave sensor unit 20 are configured to wake up from a low power mode to switch into a high power mode upon reception of a mode control signal indicative of operation in a high power mode. The control device 18 may control a power mode by providing a corresponding mode control signal based on a proximity detection signal received from a proximity sensor unit 12 as described above. Generally, controlling the power mode of any of the components of a tactile acoustic wave sensor unit 20 may be considered to be controlling the power mode of the tactile acoustic wave sensor unit 20. The high power mode of a tactile acoustic wave sensor unit 20 may be a mode in which the acquisition logic 204 of the tactile acoustic wave sensor unit 20 is active or in high power mode. The low power mode of a tactile acoustic wave sensor unit 20 may be a mode in which the acquisition logic 204 of the tactile acoustic wave sensor unit 20 is inactive or in a sleep phase.

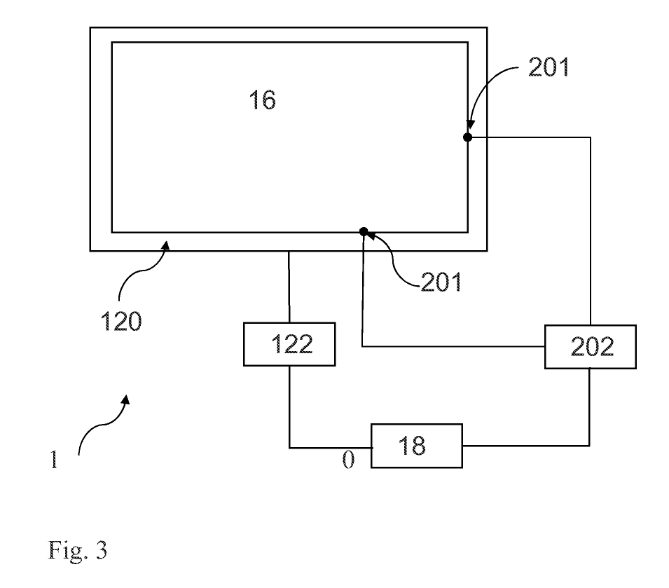

FIG. 3 schematically shows an additional example of a tactile input device 10. The tactile input device 10 may have any of the features described above. In FIG. 3 there is shown a display or tactile screen representing a tactile detection area 16. A capacitive proximity sensor unit comprises an electrode 120 surrounding the display. The electrode 120 may be a metallic band, conductive paint, wire or any conductive element. A detection logic 122 of the proximity sensor unit is connected to the electrode 120.

The capacitance value measured by the detection logic 122 changes if an object is brought into proximity of the electrode 120. Thus, a proximity detection signal indicating whether an object has been detected in a proximity detection area may be provided by the detection logic 122. The proximity sensor unit with electrode may be considered to be sensitive enough to detect any object in proximity to the tactile detection area 16, in this case the tactile screen. The detection logic 122 is connected to control device 18, which is arranged to receive a proximity detection signal from the detection logic 122 if a proximity detection occurs. A tactile localization unit 202 of a tactile acoustic wave sensor unit is connected to the control device. The tactile localization unit 202 may receive a mode control signal from the control device 18. The control device 18 may provide a mode control signal based on a proximity detection signal as described above. A tactile sensing unit may comprise a plurality of sensors 201 surrounding the tactilescreen, only two of which are shown. Sensors 201 may be piezoelectric sensors arranged to sense acoustic waves on the tactilescreen.

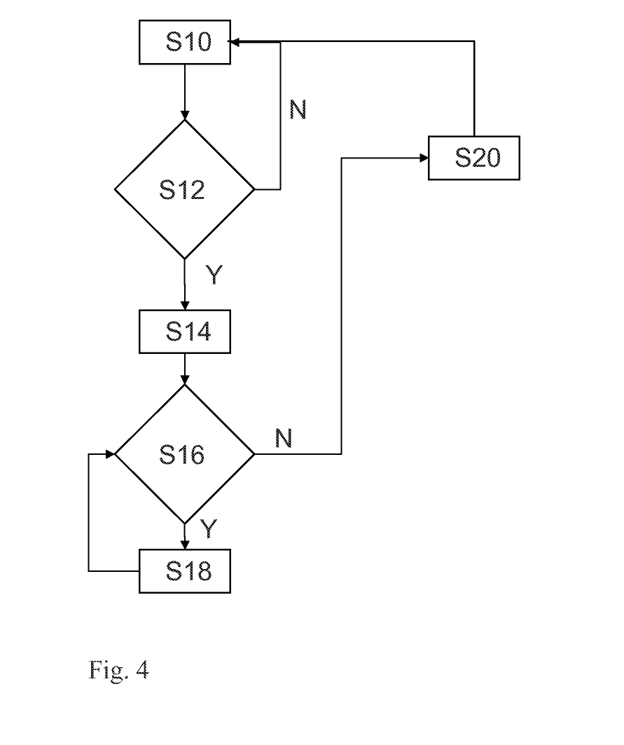

FIG. 4 schematically shows a method for controlling a tactile input device. The method may be performed by the tactile input device or its components described above. The method may comprise receiving, by a control device, a proximity detection signal from a proximity sensor unit and controlling, by the control device, a power mode of a tactile acoustic wave sensor unit based on the received proximity detection signal by providing a mode control signal to a tactile acoustic wave sensor unit. In particular, in step S10, proximity detection may be performed by a proximity sensor unit. In step S12 it may be determined whether a proximity detection occurred, i.e. whether an object was detected in the proximity detection region. Step S12 may be performed by a proximity sensor unit. If no proximity detection occurred, it may be returned to step S10. A proximity detection signal indicative of no detection occurring may be provided to a control device. If a proximity detection occurred, it may be branched to step S14. In step S14, a proximity detection signal indicative of a detection of an object may be provided to and/or received by a control device. The signal may be provided by the proximity sensor unit. Upon reception of the proximity detection signal, a mode control signal may provided to and/or received by a tactile acoustic wave sensor unit. It may be considered that the mode control signal is provided by the control device. The tactile acoustic wave sensor unit may switch into high power mode upon reception of the corresponding mode control signal.

Subsequent to step S14, step 16 may be performed. In step 16 it may be determined whether a tactile input occurred. If this is the case, the tactile input may be detected and post-processed in step S18 by the tactile acoustic wave sensor unit. From step S18 it may be returned to step S16. If no tactile input occurs for a predetermined time period, e.g. the above-mentioned waiting time or the proximity waiting time, it may be branched to step S20. In step S20, a mode control signal may be provide to and/or received by the tactile acoustic wave sensor unit controlling the tactile acoustic wave sensor unit into a low power mode. The mode control signal may be provided by the control device. The predetermined time may be chosen such that tactile inputs to a tactile detection area by a user at a typical or at a low input speed are possible without putting the tactile acoustic wave sensor unit into a low power mode. From step S20 it may be branched back to step S10.

The invention may also be implemented in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on computer readable storage medium or transmitted to the computer system via a computer readable transmission medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “above,” below“” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals and/or data from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals. A connection may be provided by a software interface connecting different software modules, procedures, processes, threads and/or programs.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein can be designed as either negative or positive logic signals. Therefore, in alternate embodiments, those signals described as positive logic signals may be implemented as negative logic signals, and those signals described as negative logic signals may be implemented as positive logic signals.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. For example, the localization logic and the acquisition logic may be implemented as a one logic block.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments

Also for example, in one embodiment, the illustrated examples may be implemented as circuitry located on a single integrated circuit or within a same device. For example, the tactile sensing logic, acquisition logic and/or localization logic of the tactile acoustic wave sensor unit may be implemented within the same device or on a single integrated circuit. It may be considered to provide the control device and the tactile localization unit on a single device. Alternatively, the examples may be implemented as any number of separate integrated circuits or separate devices interconnected with each other in a suitable manner. For example, the tactile sensing logic may be implemented separately from the tactile localization unit.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

1. A tactile input device comprising:
a control device;
a proximity sensor unit arranged to detect an object or a movement of an object in a proximity detection region and to provide a proximity detection signal to the control device indicative of a detection or non-detection of said object or movement;
a tactile acoustic wave sensor unit for detecting a tactile input, said acoustic wave sensor unit having a low power mode and a high power mode;
wherein the control device is arranged to control the tactile acoustic wave sensor unit to be in the low power mode or the high power mode by providing a mode control signal based on the proximity detection signal received from the proximity sensor unit.

2. The tactile input device according to claim 1, wherein the proximity sensor unit comprises a capacitive sensor.

3. The tactile input device according to claim 1, wherein the control device is adapted to control the tactile acoustic wave sensor unit to go in the high power mode in response to a reception of the proximity detection signal.

4. The tactile input device according to claims 1, wherein the proximity sensor unit comprises an electrode at least partially surrounding a display device.

5. The tactile input device according to claim 1, wherein the proximity sensor unit comprises an electrode made of at least one of the group consisting of: metallic paint, conductive paint, a wire, a metallic or conductive band, and a metallic layer.

6. The tactile input device according to claim 1, wherein the tactile acoustic wave sensor unit is arranged to detect a tactile input to a display.

7. The tactile input device according to claim 1, wherein the tactile acoustic wave sensor unit is arranged to detect a tactile input into a predetermined tactile detection area.

8. The tactile input device according to claim 7, wherein the tactile acoustic wave sensor unit comprises one or more sensors, surrounding the predetermined tactile detection area.

9. The tactile input device according to claim 1, wherein the high power mode is a mode in which an acquisition logic of the tactile acoustic wave sensor unit is active.

10. The tactile input device according to claim 1, wherein the low power mode is a mode in which an acquisition logic of the tactile acoustic wave sensor unit is inactive or in a sleep phase.

11. The tactile input device according to claim 1, wherein the control device controls the tactile acoustic wave sensor unit to be in the high power mode for a predetermined time after reception of the proximity detection signal.

12. The tactile input device according to claim 1, wherein the control device controls the power mode into the low power after a predetermined time after reception of the proximity detection signal.

13. Microprocessor system comprising a tactile input device according to claim 1.

14. A method for controlling a tactile input device, comprising:
receiving, by a control device, a proximity detection signal from a proximity sensor unit; and
controlling, by the control device, a power mode of a tactile acoustic wave sensor unit based on the received proximity detection signal by providing a mode control signal to a tactile acoustic wave sensor unit.

15. (canceled)

16. The tactile input device according to claim 3, wherein the tactile acoustic wave sensor unit is arranged to detect a tactile input to a display.

17. The tactile input device according to claim 3, wherein the tactile acoustic wave sensor unit is arranged to detect a tactile input into a predetermined tactile detection area.

18. The tactile input device according to claim 4, wherein the tactile acoustic wave sensor unit is arranged to detect a tactile input into a predetermined tactile detection area.

19. The tactile input device according to claim 3, wherein the high power mode is a mode in which an acquisition logic of the tactile acoustic wave sensor unit is active.

20. The tactile input device according to claim 9, wherein the low power mode is a mode in which an acquisition logic of the tactile acoustic wave sensor unit is inactive or in a sleep phase.

21. The tactile input device according to claim 10, wherein the control device controls the power mode into the low power after a predetermined time after reception of the proximity detection signal.
